(19) United States
(12) Patent Application Publication
(10) Pub. No.: US 2019/0000130 A1
(43) Pub. Date: Jan. 3, 2019

(54) AGRICULTURAL SYSTEM AND METHOD FOR LETTUCE

(71) Applicant: Go Green Agriculture, Inc., Encinitas, CA (US)

(72) Inventors: Pierre Emil Sleiman, San Diego, CA (US); Pierre Sleiman, La Jolla, CA (US)

(73) Assignee: Go Green Agriculture, Inc., Encinitas, CA (US)

(21) Appl. No.: 16/020,690

(22) Filed: Jun. 27, 2018

Related U.S. Application Data
(60) Provisional application No. 62/525,974, filed on Jun. 28, 2017.

(51) Int. Cl. A23N 15/00; A01G 9/24; A01G 9/28; A01D 45/26; A01G 31/04; B65B 11/00; B65G 49/05

(52) U.S. Cl. CPC A23N 15/003; A01G 9/247; A01G 9/28; B65G 2201/0211; A01G 31/042; B65B 11/004; B65G 49/05; A01D 45/263

(57) ABSTRACT

A method is disclosed that includes growing romaine lettuce in a greenhouse using a hydroponic technique and using purified water. The romaine lettuce has a heart and outer leaves. The heart is separated from the outer leaves of the romaine lettuce. The outer leaves are packaged in a first container and the heart is packaged in a second container. The first container and the second container are separate from one another. The first container and the second container are transferred to a storage device of approximately 32 to 41 degrees F. The packaging the outer leaves and the heart, and the transferring the first container and the second container, occur in an environment of less than or equal to 41 degrees F. The method occurs in a single, environmentally-controlled facility.

### RELATED APPLICATIONS

This application claims priority to U.S. Provisional Patent Application No. 62/525,974 filed on Jun. 28, 2017 and entitled “Lettuce Harvesting,” which is hereby incorporated by reference in full.

### BACKGROUND

There are many varieties of lettuce available. One variety, romaine, has an elongated, tall head of sturdy dark green outer leaves with firm ribs down their centers and smaller, yellow inner leaves. Romaine lettuce is a desirable produce product for a number of reasons, including its high nutrient content. Typically, romaine lettuce is grown outdoors and harvested manually, by hand, or by machinery.

For decades, the industry standard for romaine lettuce has been to use only the inner part, known as a heart or core, of the romaine lettuce and discard the outer leaves. In conventional practice during harvest, only a certain part or parts of the romaine lettuce are desirable or usable which may vary depending on the application. For example, the outer leaves may be damaged or contaminated and rendered unusable due to weather conditions (e.g., rain, wind), insects, pesticides, mechanical devices and/or dirt buildup or staining. It is difficult, if not impossible, to control every factor the crop is exposed to when grown outdoors. For example, contamination may occur due to untreated or unregulated water used to water the crops or from nearby runoff water.

The unusable portions of the romaine lettuce are trimmed away as waste to decompose wherever they fall in the field. For example, in some cases, the desirable part of the romaine lettuce may be only the heart, therefore the outer leaves are removed and unused. In another example, the undesirable part of the romaine lettuce may be the upper part of the outer leaves which become waste.

This labor-intensive step of removing the undesirable parts of the romaine lettuce depends on the skill of the cut to maximize the desirable portions and minimize the unusable, waste portions of the harvested produce. A poorly cut romaine lettuce will result in too much waste material remaining attached to the produce, or too much desirable portions being accidently removed and thereby becoming waste. Generally, this is an inefficient use of an agricultural product. In addition, as soon as the romaine lettuce is harvested, as in typical outdoor field conditions, the quality deteriorates rapidly.

### SUMMARY

A method is disclosed that includes growing romaine lettuce in a greenhouse using a hydroponic technique and using purified water. The romaine lettuce has a heart and outer leaves. The heart is separated from the outer leaves of the romaine lettuce. The outer leaves are packaged in a first container and the heart is packaged in a second container. The first container and the second container are separate from one another. The first container and the second container are transferred to a storage device of approximately 32 to 41 degrees F. The packaging of the outer leaves and the heart, and the transferring of the first container and the second container, occur in an environment of less than or equal to 41 degrees F. The method occurs in a single, environmentally-controlled facility.

A method is also disclosed that includes growing lettuce in a greenhouse using a hydroponic technique. The lettuce has a core and outer leaves. The core is separated from the outer leaves of the lettuce. The outer leaves are packaged in a first container and the core is packaged in a second container. The first container and the second container are transferred to a storage device. The packaging of the outer leaves and the core, and the transferring of the first container and the second container, occur in an environment of less than or equal to 41 degrees F.

A system is disclosed that includes a water source having purified water and a growing area for growing romaine lettuce using a hydroponic technique and using the purified water. The romaine lettuce has a heart and outer leaves. The system also includes a processing area for separating the heart from the outer leaves of the romaine lettuce and a packaging area for packaging the outer leaves in a first container and packaging the heart in a second container. A storage area stores the first container and the second container. The processing area, the packaging area and the storage area have an environment of less than or equal to 41 degrees F. The purified water source, the growing area, the processing area, the packaging area and the storage area are located in a single, environmentally-controlled facility.

### BRIEF DESCRIPTION OF THE DRAWINGS

FIG. 1 is a block diagram representing a top view of an agricultural system, in accordance with some embodiments.

FIGS. 2A-2D are perspective views of romaine lettuce, in accordance with some embodiments.

FIG. 3 is a simplified schematic of using hydroponic technology, in accordance with some embodiments.

FIG. 4 is a simplified schematic of a transport system, in accordance with some embodiments.

FIG. 5 is a perspective view of is a portion of a growing area in the facility, in accordance with some embodiments.

FIG. 6 is a view of the romaine lettuce, in accordance with some embodiments.

FIG. 7 is a simplified flowchart for an agricultural method for romaine lettuce, in accordance with some embodiments.

FIG. 8 is a simplified flowchart for an agricultural method for lettuce, in accordance with some embodiments.

### DETAILED DESCRIPTION

An agricultural system and method for romaine lettuce within a contiguous, single facility for large-scale, commercial production is disclosed. Romaine lettuce is grown, processed, packaged and stored in a single building, which may be housed under one roof. Romaine lettuce is grown indoors, for example in a greenhouse, such by using a hydroponic growing technique with purified water which uses a very small footprint compared to the amount of land needed for growing the same amount of romaine lettuce, traditionally, outdoors. The romaine lettuce grown in this manner provides two usable products of the plant, the heart (also referred to as a core) and the outer leaves.

The romaine lettuce is processed (also referred to as harvesting) by separating the heart from the outer leaves while simultaneously capturing the outer leaves removed in the process. The heart and the outer leaves are immediately cooled or refrigerated after the separation such as within seconds, optionally washed and cut, packaged and stored. All the steps may occur within an environmentally-controlled facility with no break in the supply or processing chain and without vehicle transportation such as between locations or buildings. In this way, approximately 90% or more of the outer leaves of each romaine lettuce in the agricultural method is packaged by utilizing a typically unused portion of the romaine lettuce—the outer leaves. The system and methods make it feasible to use the outer leaves before wilting as a salable product and increases the shelf life of the outer leaves and the heart. Romaine lettuce grown in a greenhouse with purified water as opposed to grown outdoors, produces a clean, safe, healthy, high-quality crop.

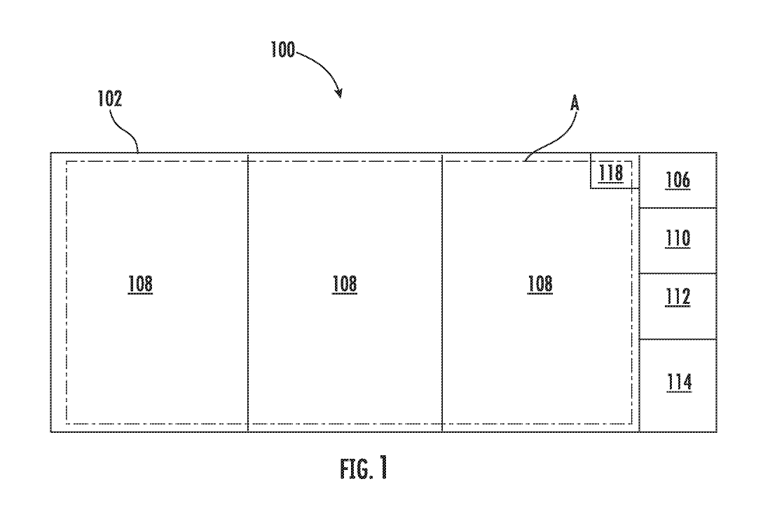

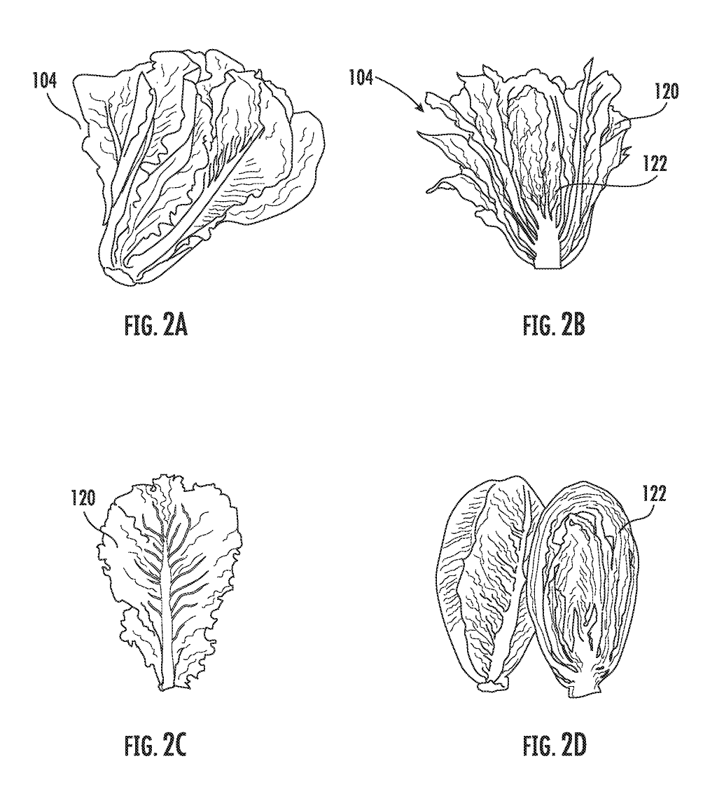

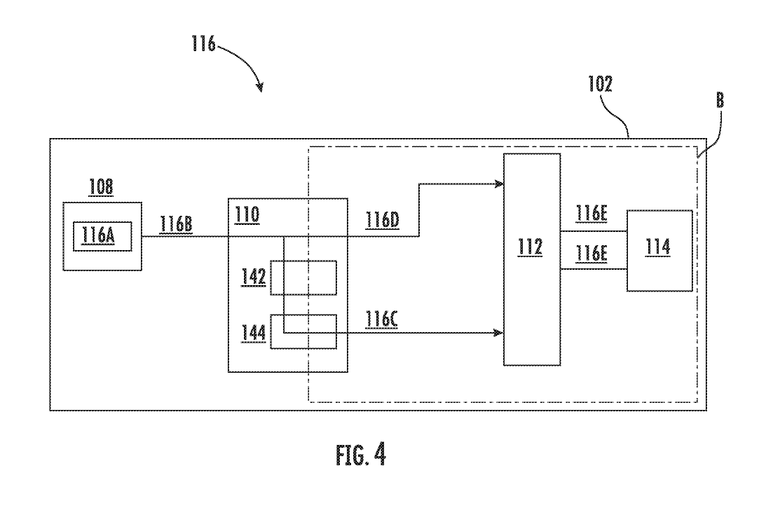

FIG. 1 is a block diagram representing a top view of an agricultural system 100, in accordance with some embodiments. The system 100 is a single facility 102 and may be a building or structure or one or more buildings within very close proximity to one another and connected together such as by tunnel or enclosed passageway. Within the single facility 102, an agricultural crop such as lettuce 104 (FIG. 2A) and more specifically, romaine lettuce may be grown, harvested, processed, and packaged for sale. In this disclosure any reference to “sale” may apply to any endpoint of the agricultural process such as general distribution, donation, or sale (retail or wholesale). The packaged products may also be stored in a cool environment within the facility 102 until shipment. The single facility 102 includes at least a water source 106, a growing area 108, a processing area 110, a packaging area 112 and a storage area 114. In some embodiments, there may be a plurality of growing areas 108 depending on the size of the operation. In this example, there are three growing areas 108. Likewise, there may be a plurality of water sources 106, processing areas 110, packaging areas 112 and storage areas 114. A transport system 116 (FIG. 4) transfers the romaine lettuce 104 to the various stations or areas of the facility 102. The transport system 116 may consist of a plurality of conveyer belts, tracks, carts or the like. The romaine lettuce 104 never leaves the single facility 102 during an agricultural method.

The facility 102 is environmentally-controlled and the settings for at least temperature, humidity, light and air-flow may be customized to fit the needs. For example, the growing area 108 may be warmer and more humid than the storage area 114. Different conditions may also be set within a particular area, such as a growing area 108 depending on the growth cycle of the agricultural crop. The transport system 116 throughout the facility 102 is also exposed to the environmentally-controlled settings and can be set for customized needs. In this way, the temperature and humidity of the lettuce 104 can be controlled during the entire agricultural methods which contribute to the high-quality product by reducing the risk of wilting and extending shelf life of the final products. The facility 102 may have a pressure control system 118 that regulates the pressure in the facility 102. The different areas of the facility 102 may have the same pressure or different settings could be used according to the needs. In some embodiments, the facility 102 has a positive pressure environment relative to an external environment. In some embodiments, this is 0.05 to 0.08 inches water column (wc). Referring to FIG. 1, the box with the broken lines and labelled as A indicates the areas of the facility 102 that in some embodiments, have the positive pressure environment. In this way, pressure within the facility 102 is greater than the environment that surrounds that facility 102—the outdoors. Consequently, if there is any leak from the positively pressured facility 102, it will egress into the surrounding environment. This ensures there is no ingress into the facility 102 thereby significantly reducing the risk of pests, insects and disease in the facility 102 that may affect the plants of romaine lettuce 104.

The facility 102 may be Global Food Safety Initiative (GFSI) certified. This certification provides continuous improvement in food safety management systems to ensure confidence in the delivery of safe food to consumers worldwide.

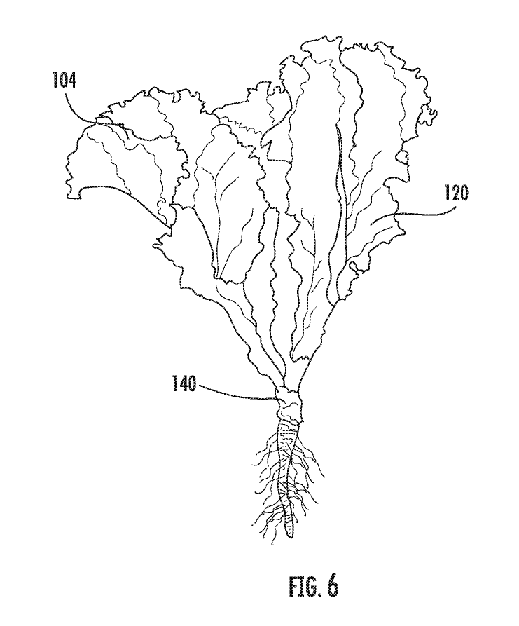

FIGS. 2A-2D are perspective views of romaine lettuce 104, in accordance with some embodiments. FIG. 2A is a head of romaine lettuce 104 as grown and separated from a root ball (refer to FIG. 6 for root ball 140). FIG. 2B is the head of romaine lettuce 104 sectioned to illustrate outer leaves 120 and a heart 122. The outer leaves 120 are elongated and upright which form a loose, loaf-shaped head. The outer leaves 120 are slightly curved away from the center. FIG. 2C is an outer leaf 120 which shows the dark, green outer leaf with a firm rib down its center. FIG. 2D depicts hearts 122 of the romaine lettuce 104. One heart 122 is shown whole while a second heart 122 is shown sectioned open to reveal the interior. The heart 122 consists of very densely packed leaves that grow somewhat curled over one another and are known to be lighter green to yellow with a slightly yellow center.

By popularity, the heart 122 of the romaine lettuce 104 is the most desired portion of the plant. When romaine lettuce 104 is grown outdoors, the plant is exposed to naturally occurring weather conditions and these unique conditions cause the plants to form a dense heart 122 in addition to the outer leaves 120. However, the lettuce industry has not been able to commercially produce romaine lettuce with a heart when the plant is grown indoors for large scale production such as in a greenhouse or a hydroponic growing facility. In fact, the naturally occurring weather conditions needed for proper growth of the romaine hearts are not well-understood and therefore, are difficult to replicate artificially. The formation of the heart 122 depends on many factors such as temperature, light, humidity, air flow, nutrient levels and carbon dioxide. By creating the optimal daily range of temperature and humidity conditions, as well as providing the appropriate lighting and nutrition in the environmentally-controlled facility 102, the heart 122 of the romaine lettuce 104 can form successfully.

Moreover, controlling these parameters may prevent diseases in the romaine lettuce 104. For example, tipburn reflects the inability of plants to move sufficient water and calcium to the rapidly growing leaf tissues enclosed in the heart of the lettuce plant. It is tissue damage on the leaf margins which is of particular concern on the internal heart leaves. This may limit the appearance and shelf life of lettuce and may lead to an internal bacterial breakdown or slime within the head of the romaine lettuce and thus become unhealthy and unmarketable.

Referring to FIG. 1, a plurality of growing areas 108, such as three or more, may be housed in the facility 102. These may be greenhouses daisy-chained together, such as by linking one greenhouse to another, to form a contiguous, environmentally-controlled area connected to the water source 106 and the processing area 110 of the facility 102. The operation of the facility 102 and particularly, the greenhouses in the growing areas 108, may be programmable and controlled by a processor or a network. The greenhouse allows for the cultivation of the romaine lettuce 104 by any process such as traditionally, in soil, or hydroponically. In some embodiments, organic growing methods are also employed.

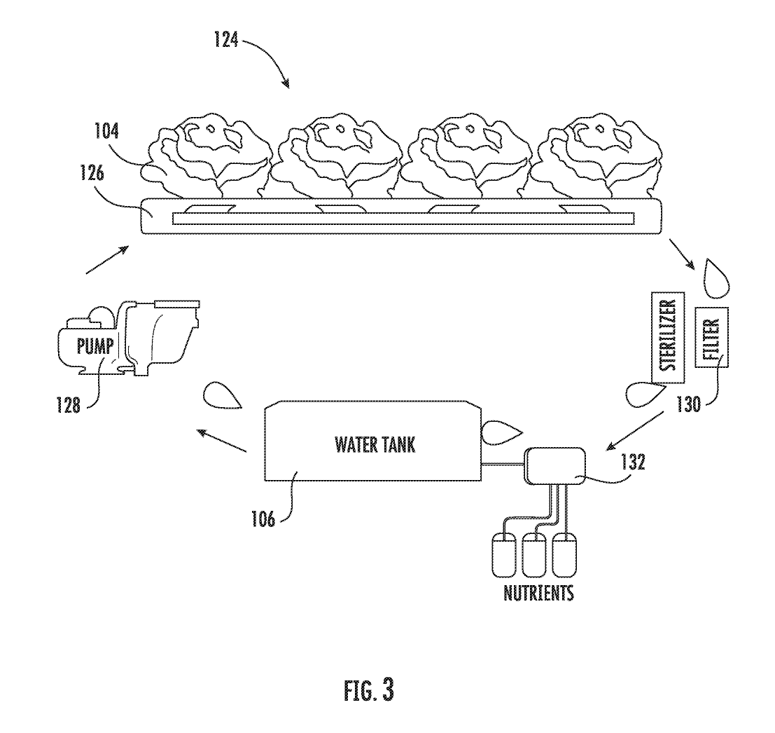

Hydroponic technology is the growing of plants in a soil-less medium, or an aquatic based environment. It uses mineral nutrient solutions to feed the plants in water, without soil. FIG. 3 is a simplified schematic of the using hydroponic technology 124, in accordance with some embodiments. A seedling which develops into the romaine lettuce 104, is placed in a tray 126. The tray 126 may be a tube, gully or channel with a plurality of apertures to accommodate a plurality of seedlings. Water from the water source 106 is transported such as by a pump 128 to the tray 126. The water may pass through a purification system 130 to be cleaned, sterilized, and treated such as by reverse osmosis, distillation or through a filtration system. Nutrients 132 may be added and mixed with the water so that a mineral nutrient solution feeds the plants through the water. The roots of the plants draw up the nutrients from the flowing solution and the downward flow of the solution is collected and recirculated or recycled in a closed loop system. Using purified water in the hydroponic method of growing the romaine lettuce 104 decreases the risk of chemical or biological contamination. Additionally, hydroponic technology 124 typically has the plants elevated and off of the ground level and thus the plants are not exposed to runoff water or ground dwelling pests.

In some embodiments, the hydroponic technology 124 may use approximately 80% less water than conventional field growing with virtually zero waste of the water. In this way, water that the plants do not use is recaptured, purified, treated and pumped back into the closed loop system for use. Rain water may be taken advantage of by capturing this free water in collection bins then introducing it into the closed loop system to go through the steps of purification and treatment. The hydroponic technology 124 may be programmable and controlled by a processor or a network so that pulse irrigation is utilized. For example, pulse or short but numerous watering events based on how much water the plant needs, in real-time, may be used. This contributes to saving water and increases the efficiency of the process.

The greenhouse in the growing area 108 has the transport system 116 which easily and conveniently moves the plant through the agricultural method starting as a seedling, with little to no human contact. FIG. 4 is a simplified schematic of the transport system 116, in accordance with some embodiments. The facility 102 in the embodiment of FIG. 4 includes growing area 108, processing area 110, packaging area 112 and storage area 114. Processing area 110 has a washing station 142 and a cutting station 144. The tray 126 containing the seedling of romaine lettuce 104 is placed upon the transport system 116 which in some embodiments, may be a conveyer as part of a transport system 116. The transport system 116 may include a first conveyer 116A, a second conveyer 116B, a third conveyer 116C, a fourth conveyer 116D and a fifth conveyer 116E. The tray 126 may hold a single plant or a plurality of plants. The plant of the romaine lettuce 104 in the tray 126 starts as a seedling, and is placed at a first end of a first conveyer 116A of the transport system 116. The first conveyer 116A moves forward over time thus translating the tray 126 with the plant of the romaine lettuce 104 through various conditions such as varied lighting, temperature, water and nutrients during the growth cycle.

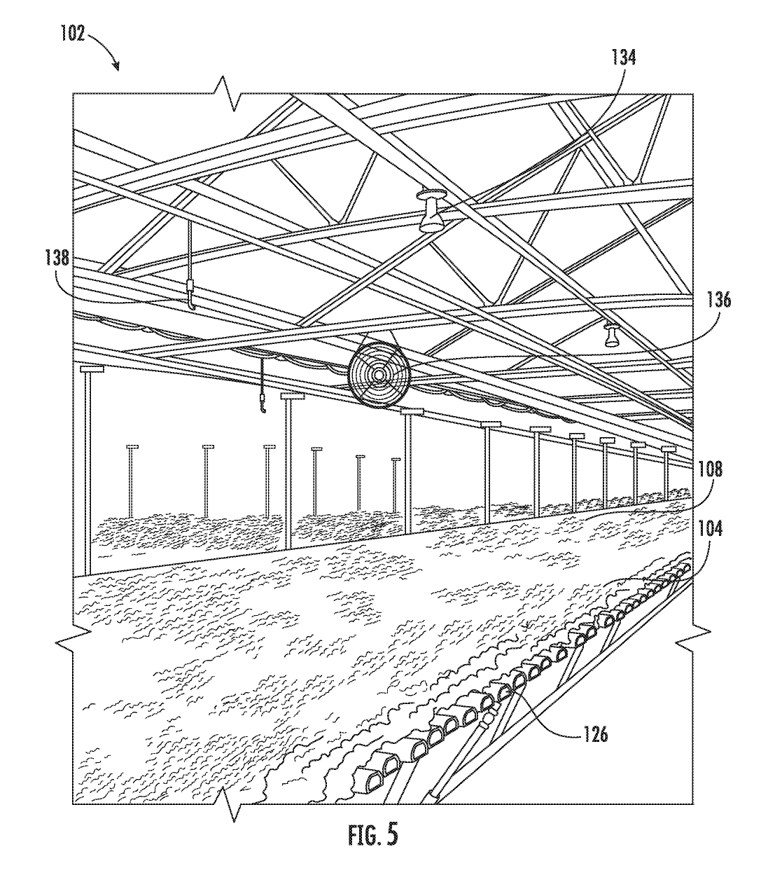

When the plant nears a second end of the first conveyer 116A, the romaine lettuce 104 is fully grown and ready for harvest. The time for the plant to move from the first end of the transport system 116 to the second end of the first conveyer 116A may be, in some embodiments, at least 30 days. This time may be adjusted for conditions such as plant variety or variation in crop. In other embodiments, the time may be at least 24 days, 33 days or 40 days. FIG. 5 is a perspective view of a portion of the growing area 108 in the facility 102, in accordance with some embodiments. In a non-limiting example, the romaine lettuce 104 in the tray 126 as shown is nearly fully grown. A light 134, a fan 136 and a mister 138 are present to control the environment. Depending on the size of the greenhouse in the growing area, there may be a plurality of lights 134, fans 136 and misters 138.

The romaine lettuce 104 is grown in a controlled environment, such as in the greenhouse by hydroponic technology 124, therefore yielding a very healthy, clean crop as opposed to when grown outdoors and exposed to the elements. For example, the greenhouse grown romaine lettuce 104 lacks pest damage, insect damage and mechanical damage, such as from weather or handling, and reduces or eliminates the need for pesticides, which provides an improvement in the quality of the romaine lettuce 104 when compared to outdoor grown romaine lettuce. When grown outdoors, the plant is susceptible to damage to the plant, such as to the outer leaves, due to the elements, fungus, insects or animals, and dirt or debris. For example, the force of rain and wind often splashes dirt on the outer leaves of the plant causing the outer leaves to become dirty and unusable. In another example, insects or animals eat the outer leaves and the damaged leaves are unusable. These outer leaves are typically unusable, trimmed away and become waste.

Returning to FIG. 5, a harvesting station or processing area 110 may be located away from the greenhouse but within the environmentally-controlled, single facility 102. Once the tray 126 with the plant of the romaine lettuce 104 is transferred from the first end of the first conveyer 116A to the second end of the first conveyer 116A, the romaine lettuce 104 in the tray 126 is fully grown and ready for harvesting. In some embodiments, the tray 126 moves from the first conveyer 116A to the second conveyer 116B as part of the transport system 116 without human contact. The romaine lettuce 104 may be moved to another part of the single facility 102 by the transport system 116 which may include the processing area 110, the packaging area 112 and/or the storage area 114. Because the romaine lettuce 104 is moved within the controlled environment, at least the temperature, humidity, light and air-flow may be set for particular conditions while on any portion of the transport system 116 (e.g., 116A, 116B, 116C, 116D and 116E).

In the processing area 110, the romaine lettuce 104 is harvested or processed by first removing the plant from the tray 126. FIG. 6 is a view of the romaine lettuce 104, in accordance with some embodiments. In some embodiments, the butt or bottom portion nearest to the roots or root ball 140 of the plant is placed in a cutting device. In some embodiments, the cutting device may be a knife, blade or the like, and the removal of the root ball may be performed manually or automated by a machine or a combination thereof. In some embodiments, the cutting device has at least a jig and a cutting surface. The cutting surface may operate in a guillotine-like way thus slicing off the root ball 140. With one cut from the cutting device, the outer leaves 120 are separated from the heart 122, and simultaneously, two usable products, the outer leaves 120 and the heart 122, are produced from one plant, the romaine lettuce 104. In various embodiments, the processing of a single plant, that is, separating the heart 122 from the outer leaves 120, is performed in less than 8 seconds, less than 10 seconds or less than 12 seconds.

Immediately after separating the outer leaves 120 from the heart 122, such as within 2 minutes, the outer leaves 120 and heart 122 are processed separately from each other. For example, in some embodiments the outer leaves 120 are released from the plant and descend by gravity onto the third conveyer 116C as part of the transport system 116. The heart 122 of the romaine lettuce 104 is placed on the fourth conveyer 116D as part of the transport system 116. Additionally, cooling or refrigeration begins immediately for the outer leaves 120 and the heart 122. In some embodiments, the outer leaves 120 and the heart 122 are exposed to a cool, refrigerated environment of less than or equal to 41 degrees, such as 32 to 41 degrees F., or 33 to 34 degrees F. A relative humidity may be 95 to 100% or 98 to 100% in this environment. This is a vital step in the method because the romaine lettuce 104 quickly degrades and wilts after the separation or harvest. The faster the romaine lettuce 104 can be cooled, the fresher the product will stay thus adding shelf life in the marketplace. Referring to FIG. 4, the box with the broken lines and labelled as B indicates the areas of the facility 102 that in some embodiments, have the cooled, refrigerated environment. In other embodiments, the areas of the facility 102 outside of the box with label B, may be environmentally controlled when necessary.

While in the cool, refrigerated environment, the third conveyer 116C moves the outer leaves 120 to an optional washing station 142. Water from the water source 106 that has been subjected to the purification system 130 to ensure the safety and integrity of the water may be used. The washing process may be minimal and fast because the original outer leaves 120 are quite clean with little to no dirt or residue since greenhouse technology was used in the growing step. The third conveyer 116C while in the cool, refrigerated environment, moves the outer leaves 120 to an optional cutting station 144. Here, the outer leaves 120 may be cut to form pre-cut pieces of the outer leaves 120 and then dried. The washing, cutting and drying may be automated by a machine performing the three tasks. In various embodiments, the outer leaves 120 are only washed, only cut, washed then cut, cut then washed or these optional steps of washing and cutting are not performed. In some embodiments, the outer leaves 120 or the pre-cut pieces of the outer leaves 120 may be processed in an additional way, such as by applying an additive to preserve freshness. The washing station 142 and cutting station 144 are in the cool, refrigerated environment as well and are located in the single facility 102. Maintaining the outer leaves 120 in a cooled, refrigerated environment aids in maintaining the highest quality of the usable product.

The fourth conveyer 116D is also in the cool, refrigerated environment and moves the heart 122 directly to the packaging area 112 bypassing the washing station 142 and the cutting station 144. In further embodiments, the heart 122 may be transferred to a washing station where the heart 122 is washed and dried as described for the outer leaves 120. Also, optionally, the heart 122 may be processed in an additional way, such as by applying an additive to preserve freshness. After traversing the processing area 110, the third conveyer 116C while in the cool, refrigerated environment, moves the outer leaves 120 (or pre-cut pieces of the outer leaves 120) to the packaging area 112.

The packaging area 112 for the outer leaves 120 and the heart 122 also has a cool, refrigerated environment of less than or equal to 41 degrees to help preserve freshness of the two usable products and is located in the single facility 102. In the packaging area 112, the outer leaves 120 are packaged in a first container and the heart 122 is packaged in a second container. The first container and the second container are different and separate from one another. The separately packaged products may be sold retail and/or wholesale depending on the application. In this way, the outer leaves 120 are sold separately from the heart 122 but one plant was used to produce two usable, salable products. From the one plant of romaine lettuce 104, approximately at least 90% of the leaves are salable and 10% or less of the leaves as well as the root ball 140 are composted. This is an improvement over the conventional method of outdoor farming of romaine lettuce 104 where the outer leaves 120 are trimmed away as waste to decompose wherever they fall in the field so that only approximately 50% of the romaine lettuce—most likely, the heart—is salable.

In the packaging area 112, from the third conveyer 116C, which are both in the cool, refrigerated environment, the outer leaves 120 (or pre-cut pieces of the outer leaves 120) are packaged in the first container. This may be via a bagging machine which packages the outer leaves 120 in a bag. The bags may hold 6 ounces, 10 ounces, 12 ounces, 1 pound or any amount of the outer leaves 120 to meet customer specifications. In other embodiments, the outer leaves 120 (or pre-cut pieces of the outer leaves 120) may be placed in a vessel, a box, a carton or the like. In some embodiments, the pre-cut pieces of the outer leaves 120 may be bagged with other items to form a prewashed, ready-to-eat salad kit. From the fourth conveyer 116D, the heart 122 is packaged in the second container. A plurality of hearts 122 may be placed into the second container which may be a bag, a vessel, a box, a carton or the like. The second container may hold one heart 122, two hearts 122, four hearts 122, six hearts 122 or any number of hearts 122 to fit the application. In some embodiments, the packaging of the outer leaves 120 and of the hearts 122, may be an automated, machine process and in other embodiments, may be a manual task.

Once packaged, the first container of outer leaves 120 and the second container of hearts 122 may be placed in a shipping receptacle such as a crate, bin, pallet or the like. The shipping receptacle is moved to the storage area 114 by the fifth conveyer 116E of the transport system 116 while being maintained in the cool, refrigerated environment. The storage area 114 may have a storage device such as a refrigerator device so the shipping receptacle with the first container of outer leaves 120 and the second container of hearts 122 can be maintained at a cool temperature until shipment to retail or wholesale facilities, general distribution, donation center or any endpoint of the agricultural process. This aids to maintaining freshness of the products until leaving the facility 102. In some embodiments, the outer leaves 120 and the heart 122 are exposed to a cool, refrigerated environment of less than or equal to 41 degrees, 32 to 41 degrees F., or 33 to 34 degrees F. in the storage device. The relative humidity may be 95 to 100% or 98 to 100% in the storage device.

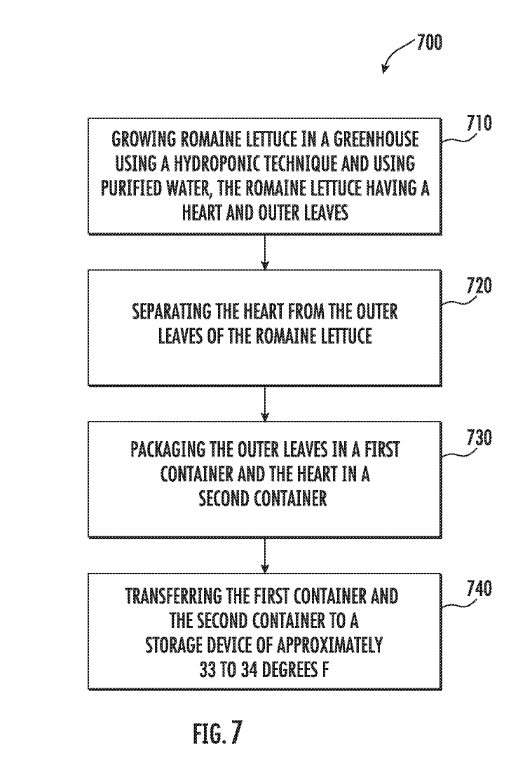

FIG. 7 is a simplified flowchart for an agricultural method 700 for romaine lettuce, in accordance with some embodiments. The agricultural method 700 is disclosed that includes at step 710, growing romaine lettuce 104 in a greenhouse using a hydroponic technique and using purified water such as by reverse osmosis, distillation or through a filtration system. The romaine lettuce 104 has a heart 122 and outer leaves 120. At step 720, the heart 122 is separated from the outer leaves 120 of the romaine lettuce 104 producing two usable products. In some embodiments, this separation also removes the root ball 140. Cooling or refrigeration of the heart 122 and the outer leaves 120 begins immediately. In some embodiments, the outer leaves 120 and the heart 122 are exposed to a cool, refrigerated environment of less than or equal to 41 degrees, 32 to 41 degrees F., or 33 to 34 degrees F. A relative humidity may be 95 to 100% or 98 to 100% in this environment. At step 730, the outer leaves 120 are packaged in a first container and the heart 122 is packaged in a second container. The first container and the second container are separate from one another. At step 740, the first container and the second container are transferred to a storage device. In this embodiment, the storage device is maintained at approximately 33 to 34 degrees with a relative humidity of 98 to 100%. The packaging the outer leaves 120 and the heart 122, and the transferring the first container and the second container occur in an environment of less than or equal to 41 degrees F. In some embodiments, this method 700 occurs in a single, environmentally-controlled facility.

In some embodiments, the separating step 720, the packaging step 730 and the transferring step 740 are performed in approximately 1 to 5 minutes. These timeframes may include the optional steps of the washing station 142 and the cutting station 144. This is feasible because the romaine lettuce 104 is transferred by the transport system 116 and never leaves the single facility 102. It is important to note that the cooling of the romaine lettuce starts immediately following the separation of the root ball 140 from the plant which simultaneously separates the outer leaves 120 from the heart 122. In contrast, the norm in the industry is to perform these steps in several hours because the romaine lettuce has to be collected from the field—at ambient temperature—loaded onto a vehicle and after some amount of time, such as when the harvesting is complete of the entire field or when the vehicle has reached capacity, the plants are then transported.

Conventional transportation is typically between sites such as a farm where the romaine lettuce 104 is grown, and a packing house where the romaine lettuce 104 is unpacked from the vehicle, processed and packaged. Moreover, the norm in the industry does not immediately start cooling the romaine lettuce 104 when the outer leaves 120 are cut away or when the romaine lettuce 104 is removed from the root ball 140. The delay could be several hours until the romaine lettuce 104 is collected from the field and reaches a refrigerated vehicle, or a refrigerated packing house, or worse case, a refrigerator device after packaging. This time delay for the romaine lettuce 104 to be cooled rapidly deteriorates and wilts the romaine lettuce.

In the agricultural method 700 for romaine lettuce, the steps of planting the seedlings and growing the romaine lettuce 104 (step 710), processing the romaine lettuce 104 into two usable products of the outer leaves 120 and the heart 122 (step 720), packaging the outer leaves 120 and the heart 122 (step 730), and transferring the outer leaves 120 and the heart 122 to storage (step 740), as well as the movement between steps, are performed in a single facility 102 which is environmentally-controlled. The romaine lettuce 104 never leaves the controlled environment or the facility 102 until shipped for distribution. This ensures the conditions, method and quality from start to finish of growing romaine lettuce 104 to shipping the product for sale. In contrast, a traditional packing house receives romaine lettuce 104 from a plurality of farms with varying quality. The romaine lettuce 104 from the plurality of farms is processed and mixed together increasing the likelihood of one batch of contaminated or low quality romaine lettuce 104 spoiling the collective romaine lettuce. Consequently, there is no way to track where the defunct crop came from and resolve the issue.

In various embodiments, the cooling or refrigerating the romaine lettuce 104 may occur before, concurrently or immediately after the separating step 720. In some embodiments, after the heart 122 is separated from the outer leaves 120, the heart 122 and outer leaves 120 are moved to the environment of less than or equal to 41 degrees F. within 20 seconds to 2 minutes, within 20 seconds to 1 minute, or 20 seconds to 1.5 minutes. Having a single, environmentally-controlled facility 102 with the transport system 116 facilitates this feature.

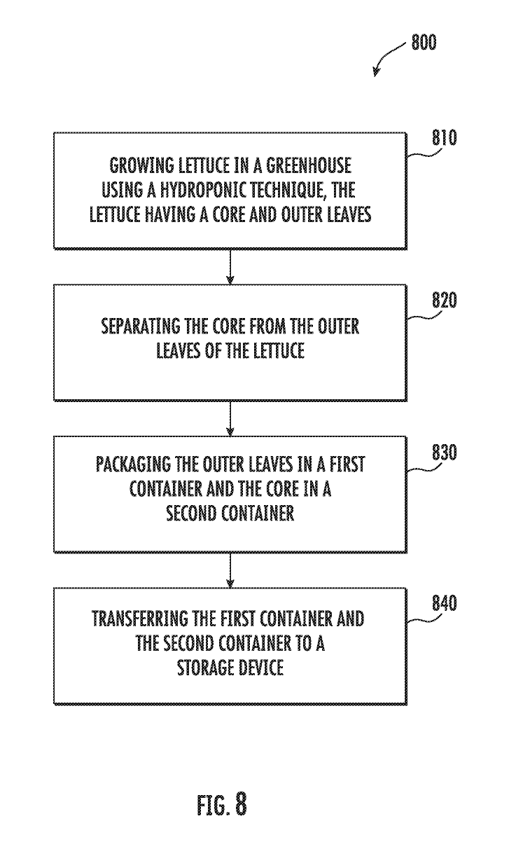

Other varieties of lettuce, leafy vegetables or other vegetables or may also be grown, processed, packaged and transferred in a similar manner. FIG. 8 is a simplified flowchart for an agricultural method 800 for lettuce, in accordance with some embodiments. The agricultural method 800 for lettuce is disclosed that includes at step 810, growing lettuce in a greenhouse using a hydroponic technique. The lettuce has a core and outer leaves. Purified water such as reverse osmosis water may be used in the hydroponic technique. At step 820, the core is separated from the outer leaves of the lettuce producing two usable products. In some embodiments, this separation also removes the roots. At step 830, the outer leaves are packaged in a first container and the core is packaged in a second container. The first container and the second container are separate from one another. At step 840, the first container and the second container are transferred to a storage device. The packaging the outer leaves and the core, and the transferring the first container and the second container occur in an environment of less than or equal to 41 degrees F. In some embodiments, this method 800 may occur in a single, environmentally-controlled facility.

The methods and system herein teach growing, processing, packaging and transferring of the product, such as romaine lettuce 104, in a single, environmentally-controlled facility 102 which eliminates outdoor element concerns, waste, and transportation factors, thus saving time and money. The transport system 116 within the single facility 102 can be in a cool, refrigerated environment that enables the romaine lettuce 104 to move from area to area in an efficient, convenient manner without human contact thus further saving time and ultimately, cost. Romaine lettuce 104 typically deteriorates rapidly as soon as the root ball 140 is removed. A vital aspect in the method 700 is cooling or refrigerating the romaine lettuce 104 as soon as the heart 122 is separated from the outer leaves 120 which may coincide with when the root ball 140 is removed from the plant. This may be referred to as harvesting or cutting.

Having a clean, healthy, contamination-free crop is important in the industry and as well as the facility 102 being certified such as Global Food Safety Initiative (GFSI) certified. The methods and system use purified water in the growing technique to reduce the risk of chemical or biological contamination in the romaine lettuce 104. The single facility 102 where the romaine lettuce 104 is grown has a positive pressure environment compared to its surroundings which significantly reduces the risk of pest, insects and disease in the romaine lettuce 104. The transport system 116 minimizes human handling of the product thereby reducing risk of contamination. The transport system 116 also facilitates immediate cooling of the products when processed which reducing the time to refrigeration and increases shelf life of the products. Understanding the natural growing conditions of romaine lettuce 104 and replicating the parameters in an indoor facility free of dirt, debris, ground water runoff and other natural elements, ensures the heart 122 forms in the romaine lettuce 104. This creates two usable products—the outer leaves 120 and the heart 122—to be sold from one plant, utilizing approximately 90% of the plant. The system and methods have little to no human contact which reduces the risk of contamination and infection of the romaine lettuce 104.

It is rare to use greenhouse technology for commercial, mass production of romaine lettuce because of the considerable expense to build and maintain the greenhouse and the lack of knowledge to replicate the parameters of the natural growing conditions. Growing the romaine lettuce in the greenhouse is expensive and typically cost prohibitive in the industry, but this method uses a smaller footprint of land and resources for the same yield of romaine lettuce 104 as when grown outdoors. The challenge exists to understand and replicate the parameters—temperature, light, humidity, air flow, nutrient levels and carbon dioxide—of the natural conditions that occur during the growing cycle of romaine lettuce that produces a heart when grown outdoors in the environment. When romaine lettuce 104 is grown in artificial conditions such as a greenhouse, it is a complex science of temperature, light, humidity, air flow, nutrient levels and carbon dioxide in order to have a dense heart form in the romaine lettuce.

Processing the romaine lettuce 104 into two salable products, such as the outer leaves 120 and the heart 122, is a significant feature of the present disclosure because it is counterintuitive in the industry. In the present disclosure, the romaine lettuce 104 is grown in a controlled environment, such as the greenhouse using purified water, therefore yielding a very clean, healthy crop without leaf damage or contamination. This enables not only the heart 122 to be salable but the outer leaves 120 to be sold as another stream of revenue thereby simultaneously producing two usable, salable products from one plant and increasing the revenue per plant. This increases revenue so the cost of using greenhouse technology may be justified. In contrast, when the romaine lettuce 104 is grown outdoors, it is at the ground level and exposed to the elements making the plant susceptible to damage and contamination by fungus, insects or animals, dirt or debris, and unsafe water such as from untreated or unregulated water used to water the crops or from nearby runoff water. The norm in the industry is to cut off or trim away the outer leaves and abandon the outer leaves wherever they fall to decompose because the outer leaves are generally undesirable, unsalable and difficult to collect. For example, the outer leaves may be excessively dirty, damaged from insects, animals or fungus, or impractical to gather. This teaches away from the present disclosure and is wasteful and an inefficient use of the plant.

Reference has been made in detail to embodiments of the disclosed invention, one or more examples of which have been illustrated in the accompanying figures. Each example has been provided by way of explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
growing romaine lettuce in a greenhouse using a hydroponic technique and using purified water, the romaine lettuce having a heart and outer leaves;
separating the heart from the outer leaves of the romaine lettuce;
packaging the outer leaves in a first container and the heart in a second container, wherein the first container and the second container are separate from one another; and
transferring the first container and the second container to a storage device of approximately 32 to 41 degrees F.;
wherein the packaging the outer leaves and the heart, and the transferring the first container and the second container occur in an environment of less than or equal to 41 degrees F.; and
wherein the method occurs in a single, environmentally-controlled facility.

2. The method of claim 1, wherein 90% or more of the outer leaves of each romaine lettuce are packaged.

3. The method of claim 1, wherein the separating step, the packaging step and the transferring step are performed in a total of approximately 1 to 5 minutes.

4. The method of claim 1, wherein after the heart is separated from the outer leaves, the heart and the outer leaves are moved to the environment of less than or equal to 41 degrees F. within 20 seconds to 2 minutes.

5. The method of claim 1, further comprising, before packaging the outer leaves, cutting the outer leaves to form pre-cut pieces of the outer leaves; and
packaging the pre-cut pieces of the outer leaves in the first container.

6. The method of claim 1, further comprising washing the outer leaves before packaging.

7. The method of claim 1, further comprising moving the romaine lettuce, the heart and the outer leaves in the facility by a transport system without human contact between the steps.

8. The method of claim 1, wherein the facility has a positive pressure environment relative to an external environment.

9. A method comprising:
growing lettuce in a greenhouse using a hydroponic technique, the lettuce having a core and outer leaves;
separating the core from the outer leaves of the lettuce;
packaging the outer leaves in a first container and the core in a second container; and
transferring the first container and the second container to a storage device;
wherein the packaging the outer leaves and the core, and the transferring the first container and the second container, occur in an environment of less than or equal to 41 degrees F.

10. The method of claim 9, wherein reverse osmosis water is used in the hydroponic technique.

11. The method of claim 9, wherein the lettuce is a variety of romaine lettuce.

12. The method of claim 9, wherein the method occurs in a single, environmentally-controlled facility.

13. The method of claim 9, further comprising, before packaging the outer leaves, cutting the outer leaves to form pre-cut pieces of the outer leaves; and
packaging the pre-cut pieces of the outer leaves in the first container.

14. The method of claim 9, further comprising washing the outer leaves before packaging.

15. The method of claim 9, further comprising moving the lettuce, the core and the outer leaves in the facility by a transport system without human contact.

16. The method of claim 9, wherein the first container and the second container are separate from one another.

17. A system comprising:
a water source having purified water;
a growing area for growing romaine lettuce using a hydroponic technique and using the purified water, the romaine lettuce having a heart and outer leaves;
a processing area for separating the heart from the outer leaves of the romaine lettuce;
a packaging area for packaging the outer leaves in a first container and packaging the heart in a second container; and
a storage area for the first container and the second container;
wherein the processing area, the packaging area and the storage area are in an environment of less than or equal to 41 degrees F.; and
wherein the water source, the growing area, the processing area, the packaging area and the storage area are located in a single, environmentally-controlled facility.

18. The system of claim 17, wherein the facility is Global Food Safety Initiative (GFSI) certified.

19. The system of claim 17, wherein the facility has a positive pressure environment relative to an external environment.

20. The system of claim 17, further comprising a transport system to move the romaine lettuce, the heart and the outer leaves between the areas in the facility without human contact.
